(19) United States
(12) Patent Application Publication
(10) Pub. No.: US 2013/0314400 A1
(43) Pub. Date: Nov. 28, 2013

(54) THREE-DIMENSIONAL IMAGE GENERATING APPARATUS AND THREE-DIMENSIONAL IMAGE GENERATING METHOD

(71) Applicant: KABUSHIKI KAISHA TOSHIBA, Tokyo (JP)

(72) Inventor: Hiroaki Komaki, Tachikawa-shi (JP)

(73) Assignee: Kabushiki Kaisha Toshiba, Tokyo (JP)

(21) Appl. No.: 13/762,010

(22) Filed: Feb. 7, 2013

(30) Foreign Application Priority Data
May 28, 2012 (JP) 2012-121170

(51) Int. Cl. G06T 15/00

(52) U.S. Cl. CPC G06T 15/005
USPC 345/419

(57) ABSTRACT

According to one embodiment, a three-dimensional image generating apparatus includes: an estimating module configured to estimate, when a frame image as a display target among a plurality of frame images constituting a two-dimensional moving image based on input moving image data is one of a first predetermined number of the frame images after a scene change position, depth information indicating a depth of a three-dimensional image corresponding to the frame image as the display target based on the frame image as the display target and a second predetermined number of the frame images after the frame image as the display target; and a generator configured to generate the three-dimensional image corresponding to the frame image as the display target using the depth information.

### CROSS-REFERENCE TO RELATED APPLICATIONS

This application is based upon and claims the benefit of priority from Japanese Patent Application No. 2012-121170, filed on May 28, 2012, the entire contents of which are incorporated herein by reference.

### FIELD

Embodiments described herein relate generally to a three-dimensional image generating apparatus and a three-dimensional image generating method.

### BACKGROUND

Conventionally, in 3D-TVs that make it possible to view three-dimensional images with naked eyes, when 2D-to-3D conversion in which depth information is estimated from frame images constituting a two-dimensional moving image and a three-dimensional image is generated using the depth information is performed, the three-dimensional image is generated in the following manner. That is, in order to prevent lowering of image quality due to variation of the depth information among the frame images constituting the two-dimensional moving image, the depth information is estimated based on a frame image as a present display target and a plurality of frame images in the past that have been displayed before the frame image and the three-dimensional image is generated using the estimated depth information.

In the conventional techniques, at a scene change position in a moving image, depth information that is estimated based on frame images in the past that have been displayed before the scene change position is also reflected to a three-dimensional image to be generated from frame images that are displayed after the scene change position. As a result, the three-dimensional image is generated using wrong depth information (depth information estimated from frame images on a different scene) over a plurality of frame images that are displayed after the scene change position.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram illustrating a configuration of a television receiver according to an embodiment;

FIG. 2 is an exemplary diagram for explaining processing of generating metadata on the television receiver in the embodiment;

FIG. 3 is an exemplary flowchart illustrating the flow of the processing of generating the metadata on the television receiver in the embodiment;

FIG. 4 is an exemplary diagram for explaining processing of estimating average depth information on the television receiver in the embodiment;

FIG. 5 is an exemplary diagram for explaining processing of displaying a three-dimensional image on the television receiver in the embodiment; and

FIG. 6 is an exemplary flowchart illustrating the flow of the processing of displaying the three-dimensional image on the television receiver in the embodiment.

### DETAILED DESCRIPTION

In general, according to one embodiment, a three-dimensional image generating apparatus comprises: an estimating module configured to estimate, when a frame image as a display target among a plurality of frame images constituting a two-dimensional moving image based on input moving image data is one of a first predetermined number of the frame images after a scene change position, depth information indicating a depth of a three-dimensional image corresponding to the frame image as the display target based on the frame image as the display target and a second predetermined number of the frame images after the frame image as the display target; and a generator configured to generate the three-dimensional image corresponding to the frame image as the display target using the depth information.

A television receiver as a three-dimensional image generating apparatus according to the embodiment will now be described.

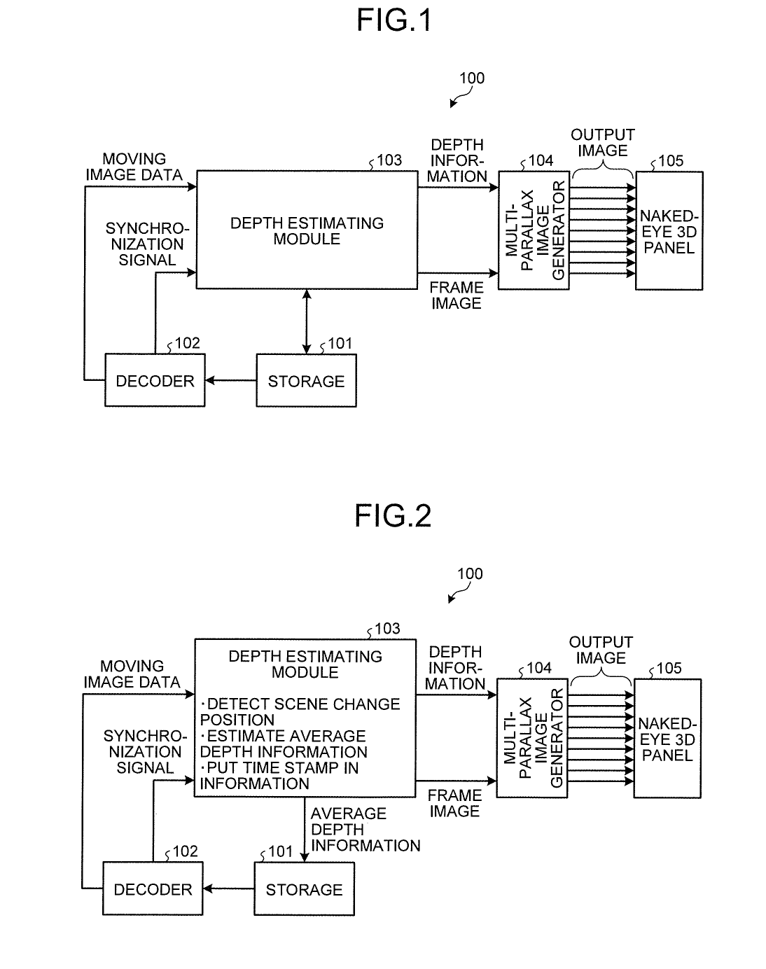

FIG. 1 is a block diagram illustrating a configuration of the television receiver according to the embodiment. As illustrated in FIG. 1, a television receiver 100 according to the embodiment comprises a storage 101, a decoder 102, a depth estimating module 103, a multi-parallax image generator 104, and a naked-eye 3D panel 105.

The storage 101 is a storage module that is constituted by a hard disk drive (HDD), for example, and stores therein moving image data. In the embodiment, the storage 101 stores therein a file (hereinafter referred to as a compressed moving image file) in which moving image data is compressed.

The decoder 102 returns the compressed moving image file stored in the storage 101 to (uncompressed) moving image data of baseband. Then, the decoder 102 inputs the moving image data returned to the baseband to the depth estimating module 103.

Furthermore, the decoder 102 outputs a synchronization signal that is synchronized with the processing of returning the compressed moving image file to the moving image data of baseband to the depth estimating module 103.

The depth estimating module 103 estimates depth information of a three-dimensional image corresponding to a frame image as a display target among a plurality of frame images constituting a two-dimensional moving image based on the input moving image data. In the embodiment, the depth estimating module 103 performs the processing of estimating the depth information of the three-dimensional image corresponding to the frame image as the display target in accordance with the synchronization signal output from the decoder 102. With this, the depth estimating module 103 estimates the depth information of the three-dimensional image corresponding to the frame image as the display target in synchronization with the processing of returning the compressed moving image file to the moving image data of baseband by the decoder 102. Furthermore, the depth estimating module 103 outputs the frame image as the display target and the depth information estimated from the frame image as the display target to the multi-parallax image generator 104.

In the embodiment, the moving image data obtained by returning the compressed moving image file stored in the storage 101 to the baseband is input to the depth estimating module 103. However, for example, moving image data input through a tuner or moving image data obtained by switching a frame rate by a frame rate controller (FRC) may be input to the depth estimating module 103.

To be more specific, the depth estimating module 103 estimates the depth information of the three-dimensional image corresponding to the frame image as the display target using at least any one of a motion 3D, a base line 3D, and a face 3D. The motion 3D detects motions of subjects (substances) comprised in the frame image as the display target using a plurality of frame images comprising the frame image as the display target so as to estimate the depth information based on the detected result thereof. To be more specific, the motion 3D estimates a front-rear relationship (depth information) of the substances based on a basic principle that a substance moving fast is closer and a substance moving slowly is farther among the subjects (substances) comprised in the frame image as the display target. The base line 3D estimates the depth information based on the composition of the frame image as the display target. To be more specific, the base line 3D estimates the depth information from a histogram of colors on four corners of the frame image as the display target and the predetermined number of (for example, 1400) sample images. The face 3D estimates the depth information using a face of the subject (person) comprised in the frame image as the display target. To be more specific, the face 3D detects the face of the person from the frame image as the display target so as to estimate the depth information with reference to a position of the detected face.

When a generation signal of instructing to generate a three-dimensional image has been input, the multi-parallax image generator 104 generates a three-dimensional image corresponding to the frame image as the display target that has been output from the depth estimating module 103 using the depth information output from the depth estimating module 103. In the embodiment, the multi-parallax image generator 104 generates output images (in the embodiment, parallax images at predetermined n viewing points) as parallax images at viewing points that are different from that of the frame image as the display target from the depth information output from the depth estimating module 103. If the parallax images with parallax are generated, a viewer of the television receiver 100 can perceive the output images that are displayed on the naked-eye 3D panel 105, which will be described later, as a stereoscopic image. Then, the multi-parallax image generator 104 outputs the generated output images from the n viewing points to the naked-eye 3D panel 105.

The naked-eye 3D panel 105 is a display module that displays the output images (three-dimensional image) generated by the multi-parallax image generator 104.

Next, processing of generating metadata to be used for estimation of depth information of a frame image at a scene change position among the frame images constituting the two-dimensional moving image based on the input moving image data when the compressed moving image file has been stored in the storage 101 is described with reference to FIG. 2 to FIG. 4. FIG. 2 is a diagram for explaining the processing of generating metadata on the television receiver according to the embodiment.

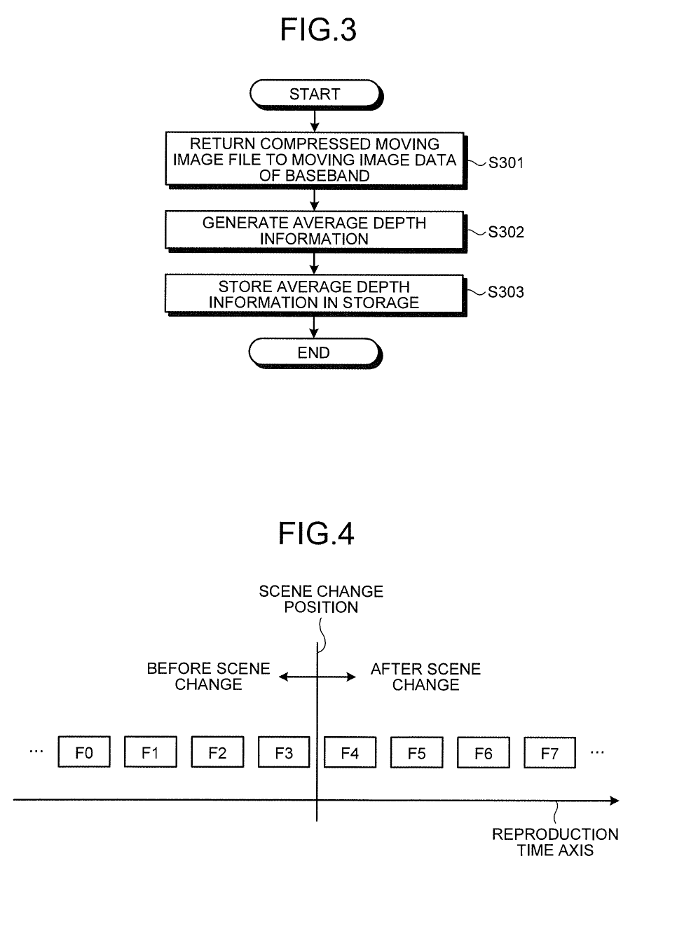

FIG. 3 is a flowchart illustrating the flow of the processing of generating the metadata on the television receiver according to the embodiment. FIG. 4 is a diagram for explaining processing of estimating average depth information on the television receiver according to the embodiment.

If a compressed moving image file has been stored in the storage 101, the decoder 102 returns the compressed moving image file to moving image data of baseband, and inputs the moving image data to the depth estimating module 103 (S301).

If the moving image data has been input, the depth estimating module 103 generates average depth information for a frame image at a scene change position among frame images constituting a two-dimensional moving image based on the input moving image data in synchronization with a synchronization signal input from the decoder 102 (S302). The average depth information is used for estimation of depth information of a three-dimensional image corresponding to the frame image at the scene change position.

To be more specific, the depth estimating module 103 detects a place (scene change position) on which a scene is switched on the two-dimensional moving image that is reproduced from the input moving image data.

If the scene change position has been detected, the depth estimating module 103 estimates pieces of average depth information for respective frame images from the scene change position for a first predetermined number of frames (in the embodiment, three frames) among the frame images constituting the two-dimensional moving image. The pieces of average depth information indicate averages of depths of three-dimensional images corresponding to the above-mentioned respective frame images and frame images from the above-mentioned respective frame images for a second predetermined number of frames (in the embodiment, fourth frames). Note that the first predetermined number of frames corresponds to the number of frame images to be used when pieces of depth information of three-dimensional images corresponding to frame images (hereinafter referred to as frame images at positions other than the scene change position) that are displayed from the scene change position for the first predetermined number of frames are estimated. The pieces of depth information of the three-dimensional images corresponding to the frame images at the positions other than the scene change position are estimated based on the frame images at the positions other than the scene change position and frame images to the frame images at the positions other than the scene change position for the first predetermined number of frames.

Furthermore, the second predetermined number of frames corresponds to the number of frame images to be used when the pieces of depth information of the three-dimensional images corresponding to the respective frame images from the scene change position for the first predetermined number of frames are estimated. In the embodiment, the second predetermined number of frames is a fixed value. However, the second predetermined number of frames may be a variable. When the second predetermined number of frames is set to the variable, the second predetermined number of frames is set in accordance with the number of frame images on scenes comprised in the two-dimensional moving image. However, the second predetermined number of frames can be changed within the number of frame images comprised in a scene when the number of frame images comprised in the scenes of the two-dimensional moving image is less than the second predetermined number of frames. Furthermore, in the embodiment, the first predetermined number of frames and the second predetermined number of frames are set to be different. However, they may be set to the same.

For example, as illustrated in FIG. 4, the depth estimating module 103 estimates average depth information for each of frame images F4 to F6 from the scene change position for three frames (first predetermined number of frames) before a generation signal is input to the multi-parallax image generator 104. To be more specific, when the average depth information is estimated for the frame image F4, the depth estimating module 103 estimates depths (hereinafter referred to as individual depth information) of three-dimensional images corresponding to frame images F4 to F7 as frames from the frame image F4 for four frame images (second predetermined number of frames) using the motion 3D, the base line 3D, and the face 3D. Then, the depth estimating module 103 estimates an average of the estimated pieces of individual depth information of the frame images F4 to F7 as the average depth information for the frame image F4. It is to be noted that the depth estimating module 103 estimates the average of the estimated pieces of individual depth information of the frame images F4 to F7 as the average depth information. Therefore, a data amount of the average depth information is depth information for one frame. The depth estimating module 103 estimates the pieces of average depth information for the frame images F5 to F6 in the same manner. If the pieces of average depth information have been estimated, the depth estimating module 103 puts pieces of positional information indicating positions of the frame images from the detected scene change position for the first predetermined number of frames in the pieces of average depth information as respective pieces of metadata. In the embodiment, the depth estimating module 103 puts positional information (time stamp) indicating a reproduction time of each of the frame images from the scene change position for the first predetermined number of frames from a head of the two-dimensional moving image in the average depth information as metadata.

Returning to FIG. 3, if the pieces of metadata have been generated, the depth estimating module 103 causes the generated pieces of average depth information to be stored in the storage 101 (S303). With this, the pieces of average depth information for the number obtained by adding one as an initial scene to the number of scene change positions comprised in the two-dimensional moving image are stored in the storage 101.

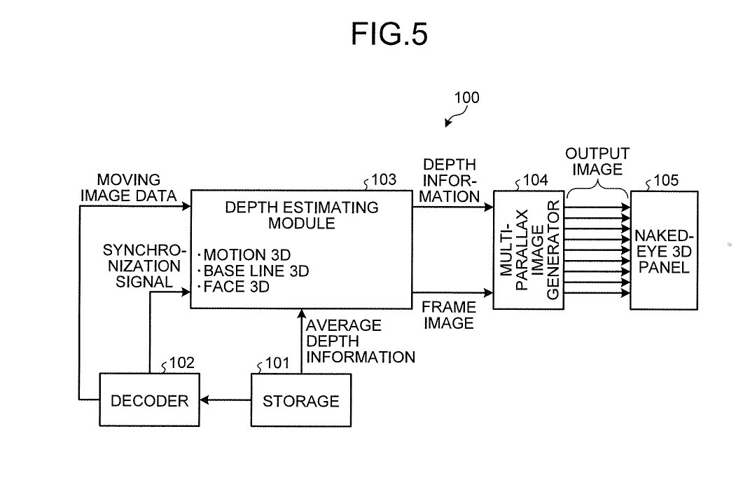

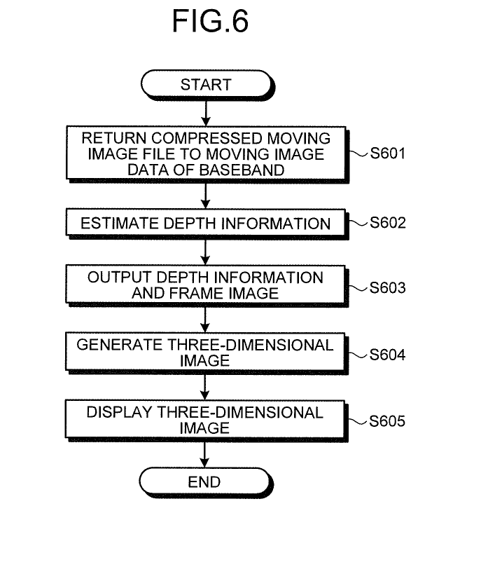

Next, the processing of displaying a three-dimensional image is described with reference to FIG. 4 to FIG. 6. FIG. 5 is a diagram for explaining the processing of displaying the three-dimensional image on the television receiver according to the embodiment. FIG. 6 is a flowchart illustrating the flow of the processing of displaying the three-dimensional image on the television receiver according to the embodiment.

If the compressed moving image file stored in the storage 101 has been instructed to be reproduced by a remote controller (not illustrated) or the like, the decoder 102 reads out the compressed moving image file that has been instructed to be reproduced from the storage 101, returns the read-out compressed moving image file to moving image data of baseband, and inputs the moving image data to the depth estimating module 103 (S601).

If the moving image data has been input from the decoder 102, the depth estimating module 103 starts reproduction of a two-dimensional moving image based on the input moving image data and estimates depth information of a three-dimensional image corresponding to a frame image as a display target among frame images constituting the reproduced two-dimensional moving image (S602).

To be more specific, the depth estimating module 103 determines whether a reproduction position (that is, reproduction time from a head of the two-dimensional moving image) of the frame image as the display target among the frame images comprised in the two-dimensional moving image based on the input moving image data is identical to a reproduction time indicated by the positional information (metadata) comprised in the average depth information stored in the storage 101. That is to say, the depth estimating module 103 determines whether the frame image as the display target is the frame images from the scene change position for the first predetermined number of frames. Then, when the reproduction position of the frame image as the display target is not identical to the reproduction time indicated by the positional information comprised in the average depth information, the depth estimating module 103 estimates depth information indicating a depth of a three-dimensional image corresponding to the frame image as the display target based on the frame image as the display target and frame images to the frame image as the display target for the first predetermined number of frames.

For example, when the frame image as the display target is a frame image F2 illustrated in FIG. 4, the depth estimating module 103 first estimates depths (individual depth information) corresponding to frame images F0 to F2, three frames back from the frame image F2, using the motion 3D, the base line 3D, and the face 3D. Next, the depth estimating module 103 calculates an average of the estimated pieces of individual depth information of the frame images F0 to F2. Then, the depth estimating module 103 calculates depth information of a three-dimensional image corresponding to the frame image F2 as the display target based on the individual depth information of the frame image F2 as the display target and the calculated average. In the embodiment, the depth estimating module 103 calculates information obtained by weighting the individual depth information of the frame image F2 as the display target and the calculated average at a ratio of 9:1 as the depth information of the three-dimensional image corresponding to the frame image F2 as the display target.

When the reproduction position of the frame image as the display target among the frame images comprised in the two-dimensional moving image reproduced from the input moving image data is identical to the reproduction time indicated by the positional information (metadata) comprised in the average depth information stored in the storage 101 (that is to say, the frame image as the display target is the frame images from the scene change position for the first predetermined number of frames), the depth estimating module 103 estimates the depth information indicating a depth of the three-dimensional image corresponding to the frame image as the display target based on the frame image as the display target and frame images from the frame image as the display target for the second predetermined number of frames. With this, when the depth information of the three-dimensional image corresponding to the frame image at the scene change position is estimated, the depth information is estimated based on the frame images that are displayed on the same scene as the frame image at the scene change position. Therefore, in this case, the three-dimensional image can be prevented from being generated using wrong depth information (depth information estimated from frame images displayed on a different scene).

In the embodiment, the depth estimating module 103 estimates individual depth information indicating the depth of the three-dimensional image corresponding to the frame image as the display target, first. Then, the depth estimating module 103 calculates the depth information of the three-dimensional image corresponding to the frame image as the display target from the average depth information comprising the positional information that is identical to the reproduction position of the frame image on the two-dimensional moving image and the estimated individual depth information.

For example, when the frame image as the display target is the frame image F4 as illustrated in FIG. 4, the depth estimating module 103 reads out average depth information comprising positional information indicating a reproduction time that is identical to a reproduction position of the frame image F4 as the display target from the storage 101. Next, the depth estimating module 103 estimates individual depth information indicating a depth of a three-dimensional image corresponding to the frame image F4 using the motion 3D, the base line 3D, and the face 3D. Then, the depth estimating module 103 calculates depth information of the three-dimensional image corresponding to the frame image F4 as the display target based on the individual depth information of the frame image F4 as the display target and the read-out average depth information. In the embodiment, the depth estimating module 103 calculates information obtained by weighting the individual depth information of the frame image F4 as the display target and the average depth information at a ratio of 9:1 as the depth information of the three-dimensional image corresponding to the frame image F4 as the display target.

Returning to FIG. 6, if the depth information of the frame image as the display target has been estimated, the depth estimating module 103 outputs the estimated depth information and the frame image as the display target to the multi-parallax image generator 104 (S603).

Next, the multi-parallax image generator 104 generates a three-dimensional image corresponding to the frame image as the display target that has been output from the depth estimating module 103 using the depth information output from the depth estimating module 103 (S604).

The naked-eye 3D panel 105 displays the three-dimensional image generated by the multi-parallax image generator 104 (S605).

As described above, with the television receiver 100 according to the embodiment, when the frame image as the display target is a frame image of frame images from the scene change position for the first predetermined number of frames, the depth information indicating the depth of the three-dimensional image corresponding to the frame image as the display target is estimated based on the frame image as the display target and frame images from the frame image as the display target for the second predetermined number of frames. Then, the three-dimensional image corresponding to the frame image as the display target is generated using the estimated depth information. With this, when the depth information of the three-dimensional image corresponding to the frame image at the scene change position is estimated, the depth information is estimated based on the frame images that are displayed on the same scene as the frame image at the scene change position. Therefore, the three-dimensional image can be prevented from being generated using wrong depth information (depth information estimated from frame images displayed on a different scene).

It is to be noted that computer programs to be executed on the television receiver 100 in the embodiment are provided by being incorporated previously in a read only memory (ROM) or the like.

Furthermore, the computer programs to be executed on the television receiver 100 in the embodiment may be configured to be provided by being recorded in a computer-readable recording medium, such as a compact disc-read-only memory (CD-ROM), a flexible disk (FD), a CD recordable (CD-R), or a digital versatile disk (DVD), in a format that can be installed or a format that can be executed.

In addition, the programs to be executed on the television receiver 100 in the embodiment may be configured to be provided by being stored on a computer connected to network such as the Internet and being downloaded through the network. Alternatively, the computer programs to be executed on the television receiver 100 in the embodiment may be configured to be provided or distributed through network such as the Internet.

The computer programs to be executed on the television receiver 100 in the embodiment has a module configuration comprising the above-mentioned parts (depth estimating module 103 and the like). As actual hardware, a CPU (processor) reads out the programs from the above-mentioned ROM and executes the programs, so that the programs are loaded on a main storage device. With this, the depth estimating module 103 is generated on the main storage device.

In the embodiment, an example in which a three-dimensional image generating method is applied to the television receiver is described. However, the invention is not limited to the example as long as parallax images (three-dimensional images) at viewing points that are different from a two-dimensional moving image from frame images constituting the two-dimensional moving image based on input moving image data and depth information corresponding to the frame images. For example, the three-dimensional image generating method can be also applied to a hard disk recorder, a personal computer, and the like.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A three-dimensional image generating apparatus comprising:
an estimating module configured to estimate, when a frame image as a display target among a plurality of frame images constituting a two-dimensional moving image based on input moving image data is one of a first predetermined number of the frame images after a scene change position, depth information indicating a depth of a three-dimensional image corresponding to the frame image as the display target based on the frame image as the display target and a second predetermined number of the frame images after the frame image as the display target; and
a generator configured to generate the three-dimensional image corresponding to the frame image as the display target using the depth information.

2. The three-dimensional image generating apparatus of claim 1, wherein the estimating module is configured to estimate average depth information for, as a specific frame image, each of the first predetermined number of the frame images after the scene change position, the average depth information of the specific frame image indicating an average of depths of the three-dimensional images corresponding to the specific frame image and the second predetermined number of the frame images after the specific frame image, estimate individual depth information indicating a depth of the three-dimensional image corresponding to the frame image as the display target, and calculate the depth information from the average depth information and the individual depth information.

3. The three-dimensional image generating apparatus of claim 2, wherein
the generator is configured to generate the three-dimensional image when a generation signal for instructing to generate the three-dimensional image is input, and
the estimating module is configured to estimate the average depth information before the generation signal is input.

4. The three-dimensional image generating apparatus of claim 3, wherein the estimating module is configured to cause a storage module to store therein the average depth information comprising positional information indicating positions of the first predetermined number of the frame images after the scene change position as metadata.

5. The three-dimensional image generating apparatus of claim 1, wherein the second predetermined number is a variable that is set in accordance with the number of frame images on each of scenes comprised in the two-dimensional moving image.

6. The three-dimensional image generating apparatus of claim 5, wherein the second predetermined number is capable of being changed within the number of the frame images comprised in each of the scenes when the number of the frame images comprised in each of the scenes is less than the second predetermined number.

7. The three-dimensional image generating apparatus of claim 1, wherein the second predetermined number is a fixed value.

8. A three-dimensional image generating method comprising:
estimating, when a frame image as a display target among a plurality of frame images constituting a two-dimensional moving image based on input moving image data is one of a first predetermined number of the frame images after a scene change position, depth information indicating a depth of a three-dimensional image corresponding to the frame image as the display target based on the frame image as the display target and a second predetermined number of the frame images after the frame image as the display target; and
generating the three-dimensional image corresponding to the frame image as the display target using the depth information.
